(19) United States
(12) Patent Application Publication
(10) Pub. No.: US 2023/0356368 A1
(43) Pub. Date: Nov. 9, 2023

(54) SPANNER FOR NUTS AND BOLTS OF DIFFERENT SIZES WITHOUT MOVING PARTS

(71) Applicants: IOANNIS ANDRIOTIS, WESLEY CHAPEL, FL (US); ELIZABETH ANDRIOTIS, WESLEY CHAPEL, FL (US)

(72) Inventor: THEODOROS GLERIDIS, KATERINI (GR)

(21) Appl. No.: 18/142,080

(22) Filed: May 2, 2023

(30) Foreign Application Priority Data
May 5, 2022 (GR) 20220100371

(51) Int. Cl. B25B 13/04; B25B 13/56

(52) U.S. Cl. CPC B25B 13/04; B25B 13/56

(57) ABSTRACT

The invention relates to a spanner for nuts and bolts, of various sizes, which has no moving parts. The spanner consists of a body (1), solid or with openings (5), to reduce weight. At the ends of the body (1) there are holes (2), polygonal in shape, where each one partially overlaps the one next to it. Holes (2), of different sizes, can also be present on each side (3) of the body (1), which are perpendicular to the inclined surface of each side (3) of the spanner.

### FIELD OF ART

The invention relates to the field of hand tools and portable tools. Even more specifically it refers to the field of tools not otherwise mentioned for fastening, connecting, disengaging and holding. In particular it refers to the field of spanners and specifically to a spanner for nuts and bolts, of different sizes, without moving parts.

### BACKGROUND OF THE INVENTION

The spanner disclosed in the present invention for nuts and bolts, of different sizes, without moving parts has not been disclosed in the prior art.

To date, a number of spanners are available on the market, the most well-known types being open-ended spanners, known (in Greek, as German spanners, adjustable jaw spanners, known (in Greek) as French spanners, and ring spanners or combinations of all of the above. All of them have disadvantages in general. Open-ended spanners, due to the fact that they are of a fixed span, can usually accommodate components of two different dimensions, as many as the ends of the spanner. This means that the user is obliged to have a multitude of spanners to ensure that his needs will be met. On the other hand, adjustable spanners have a head with moving parts so that its span can be changed and therefore fit more than two components. However, the presence of a moving part does not allow a fixed holding of the components. Finally, ring spanners are closed-end spanners and are used in very specific and limited applications. In addition to the above, all known spanners often, either due to size or construction, cannot be used in hard-to-reach places, as a result of which the user is required to perform complex movements in order to access these places and be able to use the spanner.

It is thus an object of the present invention to advantageously address the aforementioned disadvantages and shortcomings of the prior art by proposing a spanner for nuts and bolts, of various sizes, without moving parts.

It is a further object of the present invention to provide a spanner, which is designed for polygonal bolts and nuts, covering the most known sizes, without having moving parts.

It is a further object of the present: invention to provide a spanner with different sized holes, without moving parts, which depending on the side and end used, also fits different sizes of nuts and bolts.

It is a further object of the invention to disclose a spanner with holes of different sizes, without: moving parts, where each hole is partially overlapped by the immediately larger one, so as not to increase too much the size of the spanner.

It is a further object of the invention to provide a spanner for nuts and bolts of different sizes, in which the upper surface of the holes is inclined, is the last hole towards the inside being higher than the last hole towards the outside of the spanner, while respectively all the holes are perpendicular to the inclined surface of each side of the spanner, thus securing, by this inclination, the necessary space for the user's hand when using the spanner.

In yet another embodiment of the invention, each end of the invention can be connected to the body of the spanner by means of a hinge, which will allow that the end may be rotated in both directions, up to 90′ in relation to its body, and the spanner may be used in hard-to-reach places.

These and other objects, features and advantages of the invention will become apparent in the following detailed description.

### BRIEF DESCRIPTION OF THE DRAWINGS

The invention will become apparent to those skilled in the art by reference to the accompanying drawings in which it is illustrated in an indicative, non-limiting manner.

FIG. 1 shows a plan view of the invention, the spanner having 4 different holes on each of its two ends, for the respective size of nuts and bolts.

FIG. 2 is a vertical section of a spanner for different sized nuts and bolts, showing the different holes on its two sides and on its two ends, depending on the respective dimension.

FIG. 3 is a 3D image of a spanner for nuts and bolts of different sizes, without moving parts, in accordance with the present invention.

### DETAILED DESCRIPTION OF A PREFERRED EMBODIMENT

Referring now to the accompanying drawings we will describe illustrative embodiments of the spanner for nuts and bolts of different sizes, so that its technical features and innovation may become apparent.

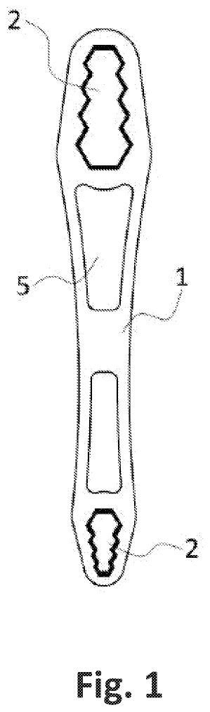

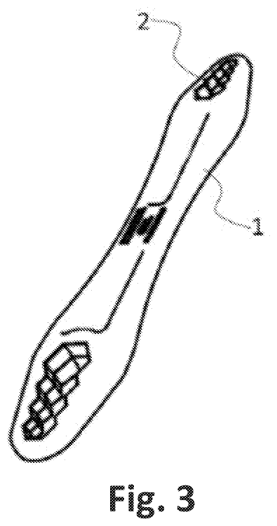

The different size, non-moving-part spanner of the present: invention consists of a single body (1), FIG. 1, with different-sized holes (2), at both ends of the body (1). At each end of the body (1) there are at least two holes (2), where each of them partially overlaps the adjacent one, FIG. 3. The size of each hole (2) increases in relation to the previous one, considering the holes (2) from the end to the center of the body (1) of the spanner. The partial overlap between the holes (2) helps reduce the overall size of the spanner. The holes (2) are designed for polygonal nuts and bolts, i.e. components with three or more sides. Therefore, the holes (2) have a triangular, square or generally polygonal shape, so that each hole (2) fits on the respective nut or bolt, with two or more vertices and with their corresponding sides.

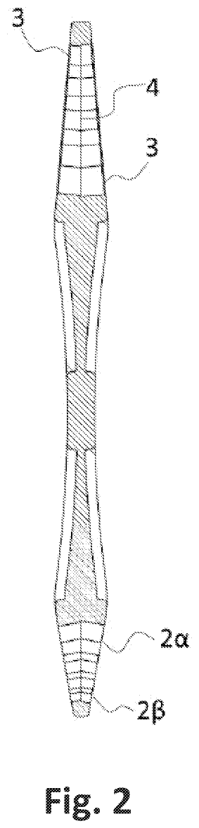

In an advantageous embodiment of the invention on each of the two sides (3), FIG. 2, of the body (1) there may be holes (2) of different sizes, so that at each end and each side (3) there are at least two holes (2), where one is overlapped by its adjacent one.

In order to have the necessary space for the user's hand, when using the spanner and especially the holes (2) towards the center, it has been designed to have the necessary inclination. Thus the upper surface of the holes (2) is inclined, with the last hole towards the inside being at a higher point compared to the last hole (2b) towards the outer point of the spanner, while respectively all the holes (2) are perpendicular to the inclined surface of each side (3) of the spanner. This avoids the user's usual movement, which requires the spanner to be tilted upwards, thereby reducing the contact of the spanner's head with the bolt or nut, in order to create the necessary space for the user to rotate a standard open-ended or adjustable spanner. The body (1) of the spanner can be compact or have one or more openings (5), mainly to reduce the total weight of the spanner, if this is deemed necessary.

In yet another alternative implementation of the invention, between the body (1) of the spanner and the holes (2) there may be a hinge, allowing the end with the holes (2) to be turned up to 90°, with respect to the central, longitudinal axis (4). Turning the end will be possible in both directions, facilitating the use of the spanner even in hard-to-reach places.

It should be noted at this point that the description of the invention was carried out with reference to illustrative embodiments, not being limited thereto. Therefore, any change or modification regarding the shape, dimensions, morphology, materials used and construction and assembly components, as long as they do not constitute a inventive step and do not contribute to the technical development of what is already known, are considered included in the purposes and visions of the present invention.

1. A spanner for nuts and bolts of various sizes without moving parts, consisting of a body (1), solid or with openings (5), with two ends, two sides (3) on either side of a central, longitudinal axis (4) of the body (1), where at least at one of the ends there are at least two holes (2), polygonal in shape and of different sizes, characterized in that the upper surface of the holes (2) is inclined, with the last hole (2a) towards inside being at a higher point with respect to the last hole (2b) towards the outer point of the spanner, while respectively all the holes (2) are perpendicular to the inclined surface of each side (3) of the spanner and each hole (2) partially overlaps its adjacent one.

2. The spanner for nuts and bolts of various sizes without moving parts, according to claim 1, characterized in that the end of each side (3) has at least two holes (2), with different dimensions.

3. The spanner for nuts and bolts of various sizes without moving parts, according to claim 1, characterized in that a hinge is inserted between the body (1) and the end, which turns up to 90° perpendicularly to the central, longitudinal axis (4).
